(19) United States
(12) Patent Application Publication
(10) Pub. No.: US 2026/0261284 A1
(43) Pub. Date: Sep. 3, 2026

(54) SIGNAL PROCESSING APPARATUS AND SIGNAL PROCESSING METHOD

(71) Applicant: NTT, Inc., Tokyo (JP)

(72) Inventors: Kazumitsu SAKAMOTO, Musashino-shi (JP); Yosuke FUJINO, Musashino-shi (JP); Kohei SUZAKI, Musashino-shi (JP); Yohei KATAYAMA, Musashino-shi (JP); Kenji SUZUKI, Musashino-shi (JP); Tomoya KAGEYAMA, Musashino-shi (JP)

(73) Assignee: NTT, Inc., Tokyo (JP)

(21) Appl. No.: 18/873,012

(22) PCT Filed: Jul. 6, 2022
(86) PCT No.: PCT/JP2022/026792

§ 371 Date: Dec. 9, 2024

(51) Int. Cl. H04B 7/01; H04B 7/185

(52) U.S. Cl. CPC H04B 7/01; H04B 7/18513

(57) ABSTRACT

A signal processing apparatus includes a Doppler variation compensation unit, a filter unit, and a reception beam control unit. The Doppler variation compensation unit compensates for a Doppler shift variation that is a time variation of a Doppler shift with respect to waveform data indicating a waveform of a wireless signal received by a communication apparatus using each of a plurality of antennas. The filter unit extracts a narrowband signal that is a signal having a bandwidth equivalent to a bandwidth of a desired signal or a bandwidth obtained by adding a predetermined margin to the bandwidth of the desired signal from each of the plurality of pieces of waveform data in which the Doppler shift variation is compensated. The reception beam control unit performs the reception beam control using an adaptive array for the plurality of the narrowband signals extracted by the filter unit.

### TECHNICAL FIELD

The present invention relates to a signal processing apparatus and a signal processing method.

### BACKGROUND ART

In recent years, satellite internet of things (IoT) platforms (satellite IoT-PFs) have been studied. The satellite IoT-PF collects sensor data from IoT terminals anywhere on the earth by a low earth orbiting satellite. An installation place of the IoT terminal includes an area that is difficult to cover in a terrestrial communication network such as on the sea or in a mountain area.

FIG. 16 is a diagram illustrating a wireless signal received by the low earth orbiting satellite on the satellite IoT-PF. In FIG. 16, a solid arrow represents a desired signal from the satellite IoT terminal, and a broken arrow represents an interference signal from a ground IoT terminal. The satellite IoT terminal is a target for collecting data on the satellite IoT-PF. The low earth orbiting satellite receives not only the desired signals transmitted from a large number of satellite IoT terminals, but also a large number of interference signals from the ground IT terminals widely spread on the ground. Therefore, the satellite IoT PF needs to extract a weak desired signal transmitted from a desired satellite IoT terminal and perform demodulation and decoding while these signals interfere with each other. As an effective method for this purpose, there is a method of mounting a plurality of reception antennas on a low earth orbiting satellite and performing reception beam control using these reception antennas (see, for example, Non Patent Literature 1).

In addition, the low earth orbiting satellite is generally required to be small, lightweight, and power saving. Meanwhile, there are many types of low power wide area (LPWA) methods used by the IoT terminals, such as LoRa (registered trademark), Sigfox (registered trademark), and ELTRES (registered trademark). When the low earth orbiting satellite includes a receiver that performs demodulation and decoding of each LPWA method, the receiver becomes complicated, which leads to an increase in power consumption. Furthermore, the low earth orbiting satellite performing the reception beam control, extracting the desired signals from the large number of desired satellite IoT terminals and demodulating and decoding the extracted signals also leads to an increase in power consumption since enormous signal processing is required in the low earth orbiting satellite. Therefore, a system configuration in which a device on the ground performs the reception beam control by offline signal processing has been studied (see, for example, Non Patent Literature 2). In this system configuration, a plurality of reception antennas is mounted on a low earth orbiting satellite. The low earth orbiting satellite transmits sampled received waveform data of each reception antenna to the ground. The device on the ground performs the reception beam control for a signal obtained from the received waveform data by offline signal processing to extract the desired signal from the satellite IoT terminal.

### CITATION LIST

### Non Patent Literature

Non Patent Literature 1: J. Chu, X. Chen, C. Zhong and Z. Zhang, “Robust Design for NOMA-Based Multibeam LEO Satellite Internet of Things”, IEEE Internet of Things Journal, vol. 8, no. 3, pp. 1959-1970, 2021.
Non Patent Literature 2: F. Yamashita, D. Goto, Y. Kojima, M. Matsui, K. Itokawa, K. Yoshizawa, K. Sakamoto, Y. Fujino, C. Kato, and M. Nakadai, “920-MHz IoT platform via LEO satellite employing feeder-link MIMO technology,” Proc. 2020 International Conference on Emerging Technologies for Communications (ICETC2020), A1-2, Dec. 2020.

### SUMMARY OF INVENTION

### Technical Problem

To extract the signal of the desired satellite IoT terminal from among the signals of a large number of satellite IoT terminals and the signals of ground IoT terminals arriving at the low earth orbiting satellite and demodulate and decode the extracted signal, it is effective to perform the reception beam control as described in Non Patent Literature 1. However, in the LPWA method with high reception sensitivity that can be used in the satellite IoT-PF, a transmission rate is as low as several 100 bits per second (bps) to realize long-distance communication. Therefore, a transmission time (frame length) per one time is generally several seconds. Since the signal is affected by a time variation of a Doppler shift caused by high-speed movement of the low earth orbiting satellite, a signal bandwidth of a signal transmitted for several seconds is spread to a wide band. Hereinafter, the time variation of the Doppler shift is referred to as a Doppler shift variation. The Doppler shift variation is obtained by differentiating the Doppler shift.

For example, it is assumed that the satellite IoT terminal using Sigfox (registered trademark) performs uplink communication in a 920 MHz band, and orbit altitude of the low earth orbiting satellite is 570 km. In this case, a Doppler shift variation amount is 310 Hz/s at the maximum. Further, the transmission signal bandwidth of the Sigfox (registered trademark) method is the width of 100 Hz and the frame length is about 2 seconds. Therefore, a frequency shifts by about 600 Hz from beginning to end of a frame. That is, the signal bandwidth at the time of reception in the low earth orbiting satellite is spread to the width of about 700 Hz at the maximum.

As a reception beam control method, adaptive arrays such as minimum mean square error (MMSE) and constant modulus algorithm (CMA, constant envelope algorithm) are widely known. In these adaptive arrays, weights for beam formation are generated. A reception level of the desired signal arriving at the low earth orbiting satellite is as very low as about −130 dBm, and an influence of thermal noise is large. Therefore, it is difficult to generate an appropriate weight only with a known signal section such as a short preamble included at a frame head of an LPWA signal. Therefore, it is effective to generate the weight using a signal waveform of the entire frame.

However, as described above, the signal bandwidth is spread several times of the original. In a case of using the entire frame, the number of interference signals superimposed within a wide frequency bandwidth after spread increases. Therefore, signal separation in a spatial domain by the reception beam control becomes difficult. A specific example will be described with reference to FIG. 17.

FIG. 17 is a diagram for describing conventional reception beam control. FIG. 17(a) is a diagram illustrating a positional relationship among wireless stations R1 to R4 with respect to a low earth orbiting satellite. The wireless station R1 is the desired Satellite IoT terminal. FIG. 17(b) is a diagram illustrating a flow of reception processing, and FIG. 17(c) is a diagram illustrating bands of transmission signals U1 to U4 from the respective wireless stations R1 to R4. The low earth orbiting satellite receives reception signals U1′ to U4′ whose bands have been spread due to the Doppler shift variation of the respective transmission signals U1 to U4. FIG. 17(d) is a diagram illustrating bands of the reception signals U1′ to U4′. As the position of the low earth orbiting satellite viewed from a wireless station is at a higher elevation angle, the Doppler shift variation becomes larger, and the band of the signal is spread.

In the case of offline beam control, the waveform data of the reception signals respectively received by the N reception antennas #1 to #N of the low earth orbiting satellite are transmitted to a ground base station. The ground base station performs the reception processing as illustrated in FIG. 17(b). Specifically, the ground base station performs frame detection for the waveform data of each of the reception antennas #1 to #N, and filters the band of the reception signal U1′, which is the desired signal, for the detected frame. The ground base station performs reception beam control for the filtered frame of each of the reception antennas #1 to #N, and then performs decoding.

FIG. 17(e) is a diagram illustrating the reception signal extracted by filtering. As illustrated in FIG. 17(d) and 17(e), the band of the reception signal U1′, which is the desired signal received by the low earth orbiting satellite, is a bandwidth several times the transmission signal U1. Many interfering signals such as the reception signals U2′ to U4′ are leaking into this bandwidth. Therefore, even if the reception beam control is performed for the filtered reception signal, the interference signals may not be completely removed, and it may be difficult to decode the desired signal.

In view of the above circumstances, an object of the present invention is to provide a signal processing apparatus and a signal processing method that realize reception beam control with good signal separation performance even in a case where a Doppler shift variation is large.

### Solution to Problem

A signal processing apparatus according to one aspect of the present invention includes: a Doppler variation compensation unit configured to compensate for a Doppler shift variation that is a time variation of a Doppler shift with respect to waveform data indicating a waveform of a wireless signal received by a communication apparatus using each of a plurality of antennas; a filter unit configured to extract a narrowband signal that is a signal having a bandwidth equivalent to a bandwidth of a desired signal or a bandwidth obtained by adding a predetermined margin to the bandwidth of the desired signal from each of a plurality of pieces of the waveform data in which the Doppler shift variation is compensated; and a reception beam control unit configured to perform reception beam control by an adaptive array for a plurality of the narrowband signals extracted by the filter unit.

A signal processing method according to one aspect of the present invention includes: a Doppler variation compensation step of compensating for a Doppler shift variation with respect to waveform data indicating a waveform of a wireless signal received by a communication apparatus using each of a plurality of antennas; a filtering step of extracting a narrowband signal of a bandwidth equivalent to a bandwidth of a desired signal or a bandwidth obtained by adding a predetermined margin to the bandwidth of the desired signal from a signal indicated by each of a plurality of pieces of the waveform data in which the Doppler shift is compensated; and a reception beam control step of performing reception beam control by an adaptive array for a plurality of the narrowband signals extracted by the filtering step.

### Advantageous Effects of Invention

According to the present invention, it is possible to realize reception beam control with good signal separation performance even in a case where a Doppler shift variation is large.

### BRIEF DESCRIPTION OF DRAWINGS

FIG. 1 A diagram illustrating a functional configuration of a wireless communication system according to an embodiment of the present invention.

FIG. 2 A block diagram illustrating a configuration of the wireless communication system according to the first embodiment.

FIG. 3 A block diagram illustrating a configuration of a base station according to the first embodiment.

FIG. 4 A block diagram illustrating a configuration of a signal processing unit according to the first embodiment.

FIG. 5 A flowchart illustrating processing of the wireless communication system according to the first embodiment.

FIG. 6 A flowchart illustrating processing of the wireless communication system according to the first embodiment.

FIG. 7 A flowchart illustrating processing of the signal processing unit and a terminal signal decoding unit according to the first embodiment.

FIG. 8 A block diagram illustrating a configuration of a signal processing unit according to a second embodiment.

FIG. 9 A flowchart illustrating processing of the signal processing unit and a terminal signal decoding unit according to the second embodiment.

FIG. 10 A block diagram illustrating a configuration of a signal processing unit according to a modification of the second embodiment.

FIG. 11 A block diagram illustrating a configuration of a mobile relay station according to a third embodiment.

FIG. 12 A block diagram illustrating a configuration of a base station according to the third embodiment.

FIG. 13 A block diagram illustrating a configuration of a wireless communication system according to a fourth embodiment.

FIG. 14 A flowchart illustrating processing of the wireless communication system according to the fourth embodiment.

FIG. 15 A flowchart illustrating processing of the wireless communication system according to the fourth embodiment.

FIG. 16 A diagram illustrating a wireless signal received by a low earth orbiting satellite in a satellite IoT-PF.

FIG. 17 A diagram for describing conventional reception beam control.

### DESCRIPTION OF EMBODIMENTS

Hereinafter, embodiments of the present invention will be described in detail with reference to the drawings. In the drawings, the same constituents are denoted by the same reference numerals, and the description thereof will be omitted.

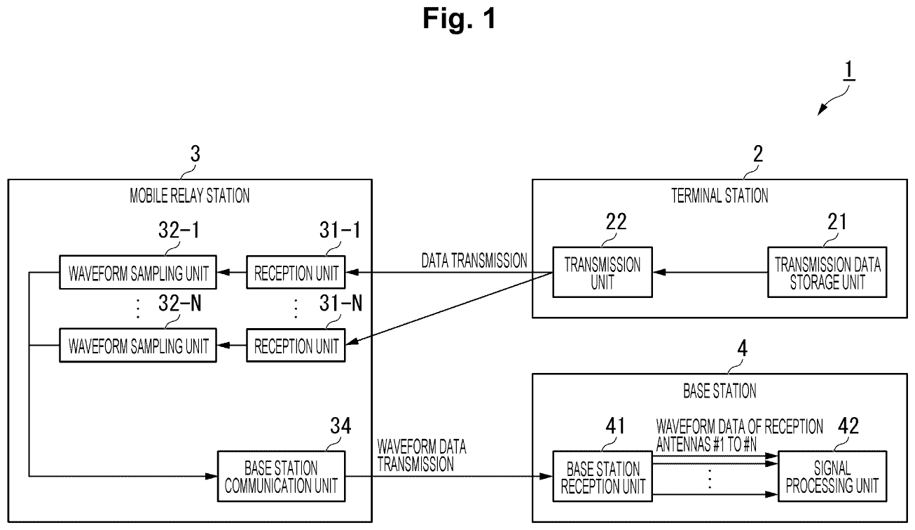

FIG. 1 is a diagram illustrating a functional configuration of a wireless communication system 1 according to an embodiment of the present invention. The wireless communication system 1 includes a terminal station 2, a mobile relay station 3, and a base station 4. The base station 4 is an example of a signal processing apparatus. In the wireless communication system 1, the numbers of the terminal stations 2, the mobile relay stations 3, and the base stations 4 are arbitrary. Note that it is supposed that the number of terminal stations 2 is large. The mobile relay station 3 moves through the sky above the earth. The terminal station 2 and the base station 4 are installed on the earth. The earth includes the ground and the sea.

Hereinafter, a wireless signal transmitted from the terminal station 2 to the mobile relay station 3 is referred to as a “terminal uplink signal”. Further, a wireless signal transmitted from the mobile relay station 3 to the base station 4 is referred to as a “base station downlink signal”.

The terminal station 2 is, for example, a satellite IoT terminal. The terminal station 2 includes a transmission data storage unit 21 and a transmission unit 22. The transmission data storage unit 21 stores transmission data. The transmission data is, for example, environment data or the like detected by a sensor. The transmission unit 22 generates the terminal uplink signal in which the transmission data read from the transmission data storage unit 21 is set. The transmission unit 22 transmits the terminal uplink signal toward the mobile relay station 3 moving in the sky by a wireless method used in a satellite IoT platform.

The mobile relay station 3 is an example of a communication apparatus that moves over time. The mobile relay station 3 moves through the sky by being mounted on a mobile object. The mobile relay station 3 is provided in, for example, a low earth orbit (LEO) satellite. The mobile relay station 3 travels around the earth along a predetermined orbit. The LEO satellite has an altitude of 2000 km or less and travels around the earth once every about 1.5 hours. The mobile relay station 3 receives the terminal uplink signal from each terminal station 2 while moving through the sky above the earth. The mobile relay station 3 accumulates data received by the terminal uplink signal. The mobile relay station 3 transmits the accumulated data to the base station 4 using the base station downlink signal at timing at which communication with the base station 4 is possible.

The mobile relay station 3 includes an antenna used for wireless communication with the terminal station 2 and an antenna used for wireless communication with the base station 4, and a frequency used for each wireless communication is generally different. Therefore, the mobile relay station 3 can execute the wireless communication related to the terminal station 2 and the wireless communication related to the base station 4 in parallel.

As the mobile relay station, it is conceivable to use a relay station mounted on a geostationary satellite, or an unmanned aerial vehicle such as a drone or a high altitude platform station (HAPS). However, in the case of a relay station mounted on a geostationary satellite, a coverage area (footprint) on the ground is large, but a link budget for satellite IoT terminals installed on the ground is very small due to its high altitude. On the other hand, in the case of a relay station mounted on a drone or a HAPS, the link budget is high, but the coverage area is small. Furthermore, the drone requires a battery, and the HAPS requires a solar panel. In the present embodiment, the mobile relay station 3 is mounted on an LEO satellite. Thus, the link budget falls within a limit, and, in addition, the LEO satellite has no air resistance and has low fuel consumption because the LEO satellite travels around the outside of the atmosphere. In addition, the footprint is larger than that in the case of the relay station mounted on the drone or the HAPS.

However, since the mobile relay station 3 mounted on the LEO satellite performs communication while moving at high speed, a time during which each terminal station 2 or base station 4 can communicate with the mobile relay station 3 is limited. Specifically, when viewed on the ground, the mobile relay station 3 passes through the sky in about several minutes. Therefore, the mobile relay station 3 mounted on the LEO satellite has a smaller link budget than the case where the relay station is mounted on the drone or the HAPS. Therefore, the mobile relay station 3 receives the terminal uplink signals from the terminal stations 2 in coverage at a current position during movement through the plurality of reception antennas and stores waveform data obtained by sampling waveforms of the terminal uplink signals received by the respective reception antennas.

For example, multiple input multiple output (MIMO) is used for the reception using the plurality of reception antennas. Communication quality can be improved by diversity effect and beamforming effect of the communication using the plurality of reception antennas.

Hereinafter, the waveform data obtained by sampling the waveform of the terminal uplink signal received by a certain reception antenna is also referred to as waveform data or received waveform data of the reception antenna.

As illustrated in FIG. 1, the mobile relay station 3 includes reception units 31-1 to 31-N, waveform sampling units 32-1 to 32-N, and a base station communication unit 34. The mobile relay station 3 includes N (N is an integer of 2 or more) reception antennas (not illustrated) that receive the terminal uplink signals. The N reception antennas are referred to as reception antennas #1 to #N. The reception unit 31-n (n is an integer from 1 to N, both inclusive) receives the terminal uplink signal through the reception antenna #n. The waveform sampling unit 32-n samples the received waveform of the terminal uplink signal received by the reception unit 31-n and stores the waveform data obtained by the sampling. The base station communication unit 34 transmits the base station downlink signal in which the waveform data of the reception antennas #1 to #N is set to the base station 4 at timing when the base station 4 exists in the coverage.

The base station 4 includes a base station reception unit 41 and a signal processing unit 42. The base station reception unit 41 obtains the waveform data from the base station downlink signal received from the mobile relay station 3. The signal processing unit 42 obtains data transmitted by the terminal station 2 by performing reception signal processing and decoding for the terminal uplink signal represented by the waveform data. In the reception signal processing, the signal processing unit 42 compensates for a Doppler shift variation that is a time variation of a Doppler shift for each received waveform data. The signal processing unit 42 extracts a narrowband signal, which is a signal equivalent to a bandwidth of the desired terminal uplink signal, from each received waveform data compensated for the Doppler shift variation, and performs reception beam control by an adaptive array using each extracted narrowband signal. As a result, sufficient signal separation performance can be achieved even for a signal having a large Doppler shift variation. The signal processing unit 42 decodes the reception signal for which the reception beam control has been performed. Each embodiment will be described below.

### First Embodiment

In a first embodiment, a Doppler shift variation is estimated using a known signal.

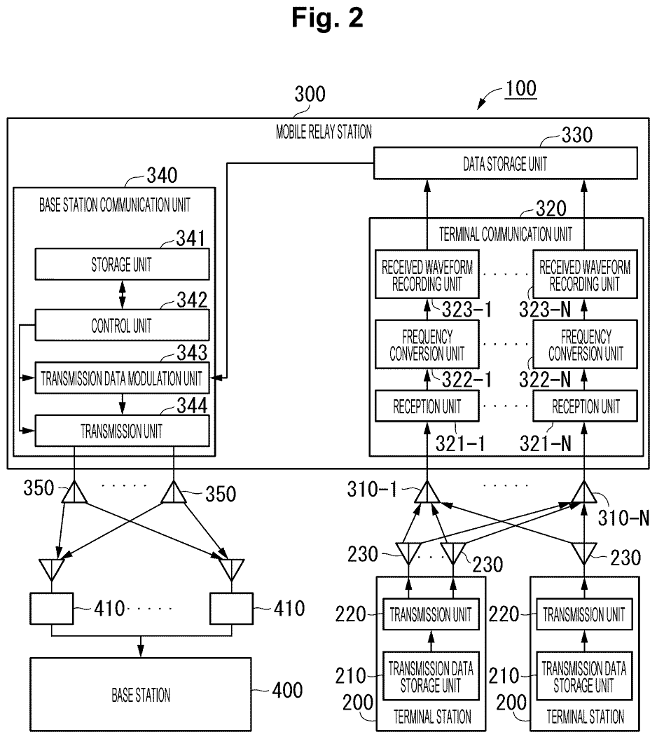

FIG. 2 is a block diagram illustrating a configuration of a wireless communication system 100 according to the first embodiment. The wireless communication system 100 includes a terminal station 200, a mobile relay station 300, and a base station 400. The wireless communication system 100, the terminal station 200, the mobile relay station 300, and the base station 400 correspond to the wireless communication system 1, the terminal station 2, the mobile relay station 3, and the base station 4 in FIG. 1, respectively.

The terminal station 200 includes a transmission data storage unit 210, a transmission unit 220, and one or a plurality of antennas 230. The transmission data storage unit 210 and the transmission unit 220 correspond to the transmission data storage unit 21 and the transmission unit 22 of the terminal station 2 illustrated in FIG. 1, respectively.

The transmission data storage unit 210 stores sensor data and the like. The transmission unit 220 reads the sensor data from the transmission data storage unit 210 as terminal transmission data. The transmission unit 220 wirelessly transmits, from the antenna 230, a terminal uplink signal in which the read terminal transmission data is set. The transmission unit 220 transmits the signal by, for example, low power wide area (LPWA). LPWA includes LoRaWAN (registered trademark), Sigfox (registered trademark), long term evolution for machines (LTE-M), narrow band (NB)-IoT, and the like, but any wireless communication method can be used. The transmission unit 220 may perform transmission with another terminal station 200 by time division multiplexing, orthogonal frequency division multiplexing (OFDM), or the like. The transmission unit 220 determines a channel to be used by its own terminal station to transmit the terminal uplink signal and transmission timing by a method determined in advance in a wireless communication method to be used.

The mobile relay station 300 includes N (N is an integer of 2 or more) antennas 310, a terminal communication unit 320, a data storage unit 330, a base station communication unit 340, and M (M is an integer of 1 or more) antennas 350. In the present embodiment, a case where M is 2 or more will be described as an example.

The antennas 310 are reception antennas that receive the terminal uplink signals transmitted from the terminal stations 200. The N antennas 310 will be referred to as antennas 310-1 to 310-N. The reception antenna #n is the antenna 310-n that has received the terminal uplink signal.

The terminal communication unit 320 includes N reception units 321, N frequency conversion units 322, and N received waveform recording units 323. The N reception units 321 are described as reception units 321-1 to 321-N, the N frequency conversion units 322 are described as frequency conversion units 322-1 to 322-N, and the N received waveform recording units 323 are described as received waveform recording units 323-1 to 323-N.

The reception unit 321-n (n is an integer from 1 to N, both inclusive) receives the terminal uplink signal through the antenna 310-n. The frequency conversion unit 322-n performs frequency conversion for the terminal uplink received by the reception unit 321-n from a radio frequency (RF) signal into a baseband signal. The frequency conversion is performed by using a quadrature demodulator or the like. The reception unit 321-n and the frequency conversion unit 322-n correspond to the reception unit 31-n in FIG. 1.

The received waveform recording unit 323-n samples the waveform of the terminal uplink signal for which the frequency conversion has been performed by the frequency conversion unit 322-n, and generates the waveform data indicating a value obtained by the sampling. The received waveform recording unit 323-n writes, to the data storage unit 330, received waveform information in which antenna identification information of the antenna 310-n, reception time of the terminal uplink signal in the antenna 310-n, and the generated waveform data are set. The antenna identification information is information for specifying each antenna 310. The received waveform recording unit 323-n corresponds to the waveform sampling unit 32-n in FIG. 1. The data storage unit 330 stores the received waveform information generated by the received waveform recording unit 323.

The base station communication unit 340 transmits the base station downlink signal to the base station 400. The base station communication unit 340 corresponds to the base station communication unit 34 in FIG. 1. The base station communication unit 340 includes a storage unit 341, a control unit 342, a transmission data modulation unit 343, and a transmission unit 344. The storage unit 341 stores transmission start timing calculated in advance on the basis of orbit information of an LEO satellite in which its own mobile relay station is mounted and a position of the base station 400. Furthermore, in a case where there is a plurality of the antennas 350, the storage unit 341 may store in advance a weight for each transmission time of the base station downlink signal transmitted from each antenna 350. The weight for each transmission time is calculated on the basis of the orbit information of the LEO satellite and a position of each antenna station 410 included in the base station 400. Note that a constant weight may be used regardless of the transmission time.

The control unit 342 controls the transmission data modulation unit 343 and the transmission unit 344 to transmit the base station downlink signals to the base station 400 at the transmission start timing stored in the storage unit 341. Furthermore, the control unit 342 instructs the transmission unit 344 on the weight for each transmission time read from the storage unit 341. The transmission data modulation unit 343 reads the received waveform information stored in the data storage unit 330 as the transmission data. The transmission data modulation unit 343 converts the transmission data into a parallel signal and then modulates the parallel signal. The transmission unit 344 weights the modulated parallel signals with the weight issued by the control unit 342 and generates base station downlink signals to be transmitted from the respective antennas 350. The transmission unit 344 transmits the generated base station downlink signal from the antenna 350 by MIMO, for example.

Each antenna 350 is a transmission antenna that wirelessly transmits a base station downlink signal. The antenna 350 may also receive a base station uplink signal wirelessly transmitted from the base station 400.

Note that, in a case where the number of antennas 350 is one, the control unit 342 does not instruct the weight to the transmission unit 344. The transmission data modulation unit 343 modulates the transmission data into a transmission signal to be transmitted from one antenna 350. The transmission unit 344 transmits the modulated transmission signal from the antenna 350.

The base station 400 includes one or more antenna stations 410. Hereinafter, a case where there is a plurality of the antenna stations 410 will be described as an example. The plurality of antenna stations 410 is arranged at positions separated from each other such that an arrival angle difference of signals from the plurality of respective antennas 350 of the mobile relay station 300 increases.

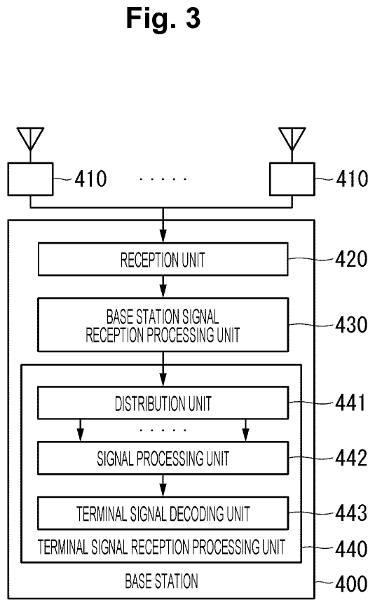

FIG. 3 is a diagram illustrating a configuration example of the base station 400. The base station 400 includes the plurality of antenna stations 410, a reception unit 420, a base station signal reception processing unit 430, and a terminal signal reception processing unit 440. The reception unit 420 and the base station signal reception processing unit 430 correspond to the base station reception unit 41 in FIG. 1, and the terminal signal reception processing unit 440 corresponds to the signal processing unit 42 in FIG. 1.

The antenna station 410 converts the base station downlink signal received from the mobile relay station 300 into an electrical signal and outputs the electrical signal to the reception unit 420. The reception unit 420 gathers the base station downlink signals received from the plurality of antenna stations 410. The reception unit 420 stores a weight for each reception time with respect to the base station downlink signal received by each antenna station 410 on the basis of the orbit information of the LEO satellite and the position of each antenna station 410. The reception unit 420 multiplies the base station downlink signal input from each antenna station 410 by the weight corresponding to the reception time of the base station downlink signal and combines the reception signals multiplied by the weights. Note that the same weight may be used regardless of the reception time.

The base station signal reception processing unit 430 receives, as an input, the reception signal combined by the reception unit 420. In a case where the number of the antenna stations 410 is one, or in a case where the base station 400 does not include the antenna station 410 and includes one antenna, the base station 400 does not include the reception unit 420, and the base station signal reception processing unit 430 inputs the base station downlink signal received from the antenna station 410 or the antenna as a reception signal. The base station signal reception processing unit 430 demodulates and decodes the input reception signal to obtain the received waveform information. The base station signal reception processing unit 430 outputs the received waveform information to the terminal signal reception processing unit 440.

The terminal signal reception processing unit 440 performs reception processing of the terminal uplink signal indicated by the received waveform information. The terminal signal reception processing unit 440 acquires the terminal transmission data by performing the reception processing according to the wireless communication method used for the transmission by the terminal station 200. The terminal signal reception processing unit 440 includes a distribution unit 441, a signal processing unit 442, and a terminal signal decoding unit 443.

The distribution unit 441 reads the waveform data of the reception antennas #1 to #N at the same reception time from the received waveform information, and outputs the read waveform data to the signal processing unit 442. The waveform data of the reception antenna #n is waveform data associated with the antenna identification information of the antenna 310-n. The signal processing unit 442 performs processing such as frame detection (terminal signal detection), Doppler shift variation compensation, filtering, and reception beam control for the waveform data of the reception antennas #1 to #N. In the present embodiment, description of other reception processing performed by general wireless communication apparatuses is omitted.

The frame detection is processing of detecting a section including a terminal transmission frame of the terminal uplink signal from the waveform data. The signal processing unit 442 performs frame detection for the waveform data of each of the reception antennas #1 to #N. The signal processing unit 442 performs the Doppler shift variation compensation for each detected terminal transmission frame to narrow the band of the desired signal, and then filters a frequency domain of the desired signal. The signal processing unit 442 performs the reception beam control using the waveform data of a filtered terminal transmission frame portion of each of the reception antennas #1 to #N. In the reception beam control, the signal processing unit 442 multiplies the waveform data of the terminal transmission frame portion of each of the reception antennas #1 to #N by a weight for performing amplitude correction and phase correction for intensifying and combining the desired signals of respective reception systems while suppressing an interference signal, and then adds and combines the waveform data. The signal processing unit 442 outputs a symbol of the reception signal obtained from the added and combined waveform data to the terminal signal decoding unit 443.

The terminal signal decoding unit 443 decodes the symbol output by the signal processing unit 442 to obtain the terminal transmission data transmitted from the terminal station 200. The terminal signal decoding unit 443 can also use a decoding method with a large calculation load, such as successive interference cancellation (SIC).

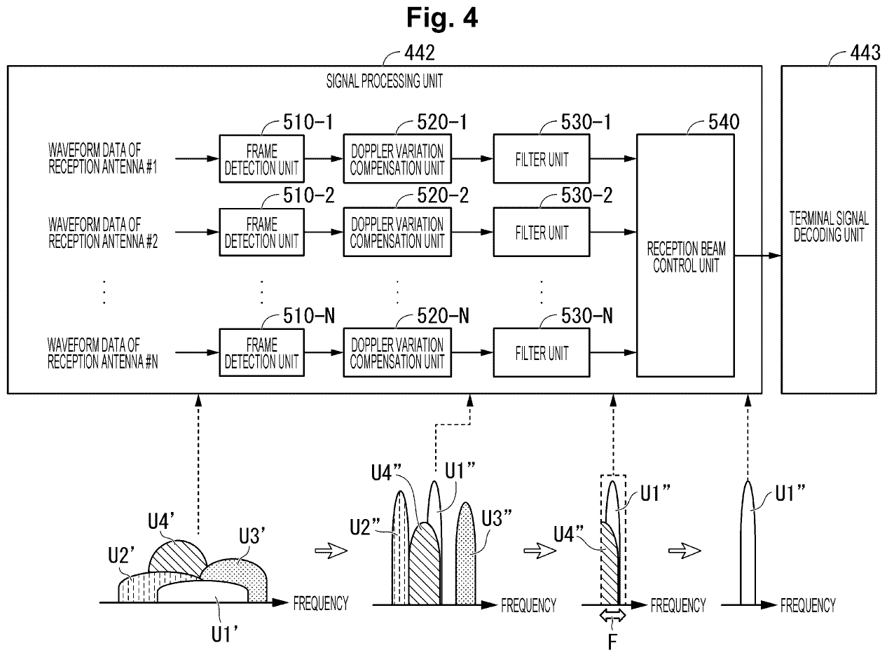

FIG. 4 is a diagram illustrating a detailed configuration of the signal processing unit 442. The signal processing unit 442 includes frame detection units 510-1 to 510-N, Doppler variation compensation units 520-1 to 520-N, filter units 530-1 to 530-N, and a reception beam control unit 540.

The frame detection unit 510-n (n is an integer from 1 to N, both inclusive) performs frame detection for the waveform data of the reception antenna #n. The frame detection unit 510-n calculates cross-correlation between a transmission known signal and the reception signal waveform indicated by the waveform data. As a result, the frame detection unit 510-n detects a predetermined position of a reception frame in the waveform data of the reception antenna #n. The transmission known signal is a known signal such as a preamble set at a predetermined position such as a frame head in a frame defined by each LPWA frame format used by a satellite IoT terminal accommodated in a Satellite IoT-PF.

Specifically, a plurality of the transmission known signals to which different types of frequency shifts f [Hz] are added are prepared in advance. A range of the Doppler shift assumed from the frequency of the terminal uplink signal and the orbit information of the mobile relay station 300 is-dfmax to dfmax. For example, in a case of transmitting the terminal uplink signal of 920 MHz to the mobile relay station 300 at an orbit altitude of 570 km, the assumed range of the Doppler shift is approximately −20 [kHz] to 20 [kHz]. The transmission known signals in which search intervals fstep is set to several Hz and each of the frequency shifts f=−dfₘₐₓ, −dfₘₐₓ+fₛₜₑₚ, −dfₘₐₓ+2×fₛₜₑₚ, . . . , dfₘₐₓ−2×fₛₜₑₚ, dfₘₐₓ−fₛₜₑₚ, dfₘₐₓ is added are prepared. These transmission known signals are stored in advance in a storage unit inside or outside the frame detection unit 510-n. The frame detection unit 510-n calculates cross-correlation between each transmission known signal and the reception signal waveform indicated by the waveform data. The frame detection unit 510-n searches for the transmission known signal having a maximum correlation value or a threshold or more, of the cross-correlation, and detects the position of the reception signal waveform from which the correlation value is obtained as a setting position of the known signal.

When detecting the setting position of the known signal in the reception frame in the waveform data, the frame detection unit 510-n extracts a section of a frame length defined by the frame format from the waveform data, or specifies an end position of the frame on the basis of information of the frame length described in a header in the reception frame and extracts a frame section.

The frequency shift added to the searched transmission known signal is substantially the same as the Doppler shift received by the terminal uplink signal of the desired signal. Therefore, the Doppler shift compensation may be performed for the waveform data, using the frequency shift added to the searched transmission known signal as an estimation value of the Doppler shift.

In the above description, the case of using the transmission known signals to which the different types of frequency shifts are added has been described. However, transmission known signals to which different types of frequency variations are also added, similarly to a Doppler shift variation compensation method B to be described below, may be used, in addition to the addition of the frequency shifts. That is, the frame detection unit 510-n may prepare a plurality of transmission known signals to which combinations of different types of frequency shifts and different types of frequency variations are added in advance, and calculate cross-correlation between each of the transmission known signals and the reception signal waveform indicated by the waveform data of the reception antenna #n. Note that the frequency variation added to the transmission known signal corresponds to the Doppler shift variation received by the terminal uplink signal. For example, in the case of transmitting the terminal uplink signal of 920 MHz to the mobile relay station 300 at the orbit altitude of 570 km, similarly to the above description, the assumed range of the Doppler shift variation is approximately −310 Hz/s to −50 Hz/s. Alternatively, the frame detection unit 510-n may use a generally used method such as detecting a section in which the time domain waveform is equal to or greater than a certain amplitude in the waveform data of the reception antenna #n as a section including the terminal transmission frame.

The Doppler variation compensation unit 520-n performs Doppler shift variation compensation for the reception frame extracted by the frame detection unit 510-n. The Doppler shift variation compensation is processing of compensating for the Doppler shift variation received by the desired signal. In the present embodiment, the Doppler variation compensation unit 520-n estimates the Doppler shift variation by either one of the following method A or B using the known signal in the reception frame, and performs compensation for canceling the estimated Doppler shift variation for the waveform data of the reception frame section. The Doppler variation compensation unit 520-n outputs the reception frame in which the Doppler shift variation is compensated to the filter unit 530-n.

(Method A) The Doppler variation compensation unit 520-n calculates (estimates) the Doppler shift variation on the basis of a phase rotation amount in a known signal section such as the head of the reception frame. The known signal section is a section in which the known signal such as a preamble is set in the reception frame. The Doppler variation compensation unit 520-n compensates for the Doppler shift variation by adding phase rotation that cancels the calculated Doppler shift variation over the entire reception frame section. Note that the LPWA method also includes a method in which the known signal is distributed and arranged in an entire packet, such as ELTRES (registered trademark). In that case, the Doppler shift variation may be estimated and compensated on the basis of the phase rotation amount received by the known signal that has been distributed and arranged. As described above, the present embodiment is not limited to the configuration using the preamble at the head of the frame.

(Method B) A plurality of variation detection signals obtained by adding frequency variations respectively corresponding to different Doppler shift variations to the known signal such as the preamble set at a predetermined position such as a frame head defined by an LPWA frame format is prepared in advance. For example, it is assumed that the Doppler shift variation assumed on the basis of a terminal uplink signal frequency that is the frequency of the terminal uplink signal and the orbit altitude of the satellite carrying the mobile relay station 300 for each time is −310 Hz/s to −50 Hz/s. In this case, a plurality of types of variation detection signals obtained by adding respective frequency variations in increments of several Hz between −310 Hz/s and −50 Hz/s to the known signal is prepared. The plurality of types of variation detection signals is stored in a storage unit inside or outside the Doppler variation compensation unit 520-n. The Doppler variation compensation unit 520-n calculates cross-correlation between the reception frame extracted from the waveform data of the antenna #n and each variation detection signal. In a case where the correlation value of the cross-correlation is the maximum or a threshold or more, the Doppler variation compensation unit 520-n uses the frequency variation added to the variation detection signal used for calculating the correlation value as the estimation value of the Doppler shift variation. The Doppler variation compensation unit 520-n compensates for the Doppler shift variation by adding the phase rotation that cancels the estimated Doppler shift variation over the entire reception frame section obtained from the waveform data of the antenna #-n.

The filter unit 530-n performs filtering for the received waveform data in the reception frame section in which the Doppler shift variation compensation has been performed by the Doppler variation compensation unit 520-n. The filtering is processing of limiting, using a narrowband filter, the band of the desired signal narrowed by the Doppler shift variation compensation. An influence of a large number of interference signals outside the desired signal band is suppressed by extracting only the band around the desired signal using the narrowband filter. A pass bandwidth of the narrowband filter is set to be the same as a transmission signal bandwidth of the desired signal defined in the LPWA method to be extracted or a bandwidth slightly wider (with a small margin) than the transmission bandwidth. The filter unit 530-n outputs the received waveform data extracted by the filtering to the reception beam control unit 540.

The reception beam control unit 540 receives, as an input, the received waveform data of a peripheral band of the desired signal extracted by the narrowband filter in each of the filter units 530-1 to 530-N. The reception beam control unit 540 performs processing of an adaptive array such as MMSE or CMA using the input received waveform data. As a result, the reception beam control unit 540 separates the interference signal remaining in a filter band in a spatial domain and extracts the desired signal. The reception beam control unit 540 outputs the extracted desired signal to the terminal signal decoding unit 443.

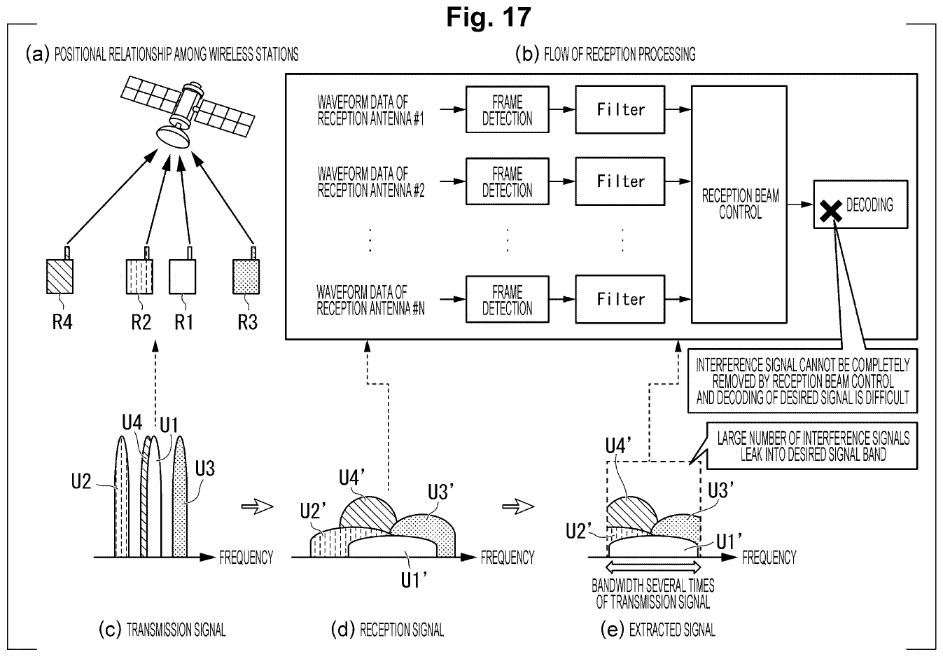

For example, it is assumed that transmission signals U1 to U4 illustrated in FIG. 17(c) are transmitted from four terminal stations 200 corresponding to wireless stations R1 to R4 illustrated in FIG. 17(a). The transmission signal U1 is the desired signal transmitted from the terminal station 200 corresponding to the wireless station R1 of a desired satellite IoT terminal. As illustrated in the lower left of FIG. 4, the reception antennas #1 to #N of the mobile relay station 300 receive reception signals U1′ to U4′ whose bands have been spread due to the Doppler shift variation of the transmission signals U1 to U4, respectively, similarly to FIG. 17(d). Since the Doppler shift variation received by the transmission signal U1 as the desired signal is compensated by the Doppler variation compensation units 520-1 to 520-N, the reception signals U1′ to U4′ are narrowed and become reception signals U1″ to U4″, respectively. The filter units 530-1 to 530-N cause the waveform data of a pass bandwidth F of the desired signal to pass using the narrowband filter, so that the reception signal is separated in the frequency domain and the interference is suppressed. The reception beam control unit 540 performs reception beam control for the reception frame in which the interference of each of the reception antennas #1 to #N is suppressed, thereby separating the interference signal and obtaining the reception signal U1″.

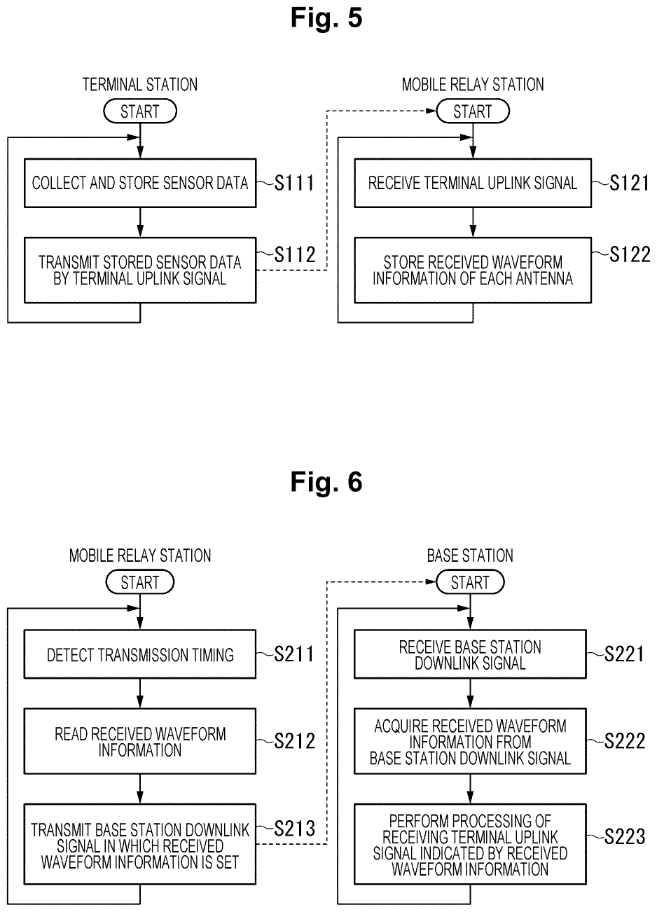

Operation of the wireless communication system 100 will be described. FIG. 5 is a flowchart illustrating processing of the wireless communication system 100 in the case of transmitting the terminal uplink signal from the terminal station 200. The terminal station 200 acquires data detected by a sensor (not illustrated) provided outside or inside at any time, and writes the acquired data in the transmission data storage unit 210 (step S111). The transmission unit 220 reads the sensor data from the transmission data storage unit 210 as terminal transmission data. The transmission unit 220 wirelessly transmits the terminal uplink signal in which the terminal transmission data is set from the antenna 230 at, for example, the transmission start timing obtained in advance on the basis of the orbit information of the LEO satellite on which the mobile relay station 300 is mounted (step S112). The terminal station 200 repeats the processing from step S111.

The reception units 321-1 to 321-N of the mobile relay station 300 receive the terminal uplink signal transmitted from the terminal station 200 (step S121). Note that uplink signals of the same frequency from a plurality of the terminal stations 200 may be simultaneously transmitted. In this case, the desired signals transmitted at the same frequency at the same time interfere with each other, but the signals are separated from each other by the reception beam control and can be received. The frequency conversion units 322-n performs frequency conversion for the terminal uplink signal received by the reception unit 321-n from an RF signal to a baseband signal. The received waveform recording unit 323-n writes the received waveform information in which the waveform data representing the waveform of the terminal uplink signal for which the frequency conversion has been performed by the frequency conversion unit 322-n, the reception time, and the antenna identification information of the antenna 310-n are associated with one another in the data storage unit 330 (step S122). The mobile relay station 300 repeats the processing from step S121.

FIG. 6 is a flowchart illustrating processing of the wireless communication system 100 in the case of transmitting the base station downlink signal from the mobile relay station 300. When having detected the transmission start timing stored in the storage unit 341, the control unit 342 included in the base station communication unit 340 of the mobile relay station 300 instructs the transmission data modulation unit 343 and the transmission unit 344 to transmit the received waveform information (step S211).

The transmission data modulation unit 343 reads the received waveform information from the data storage unit 330 as the transmission data (step S212). Here, the received waveform information read from the storage unit 341 by the transmission data modulation unit 343 is received waveform information in which the reception time at or after the reception time set in the received waveform information read last by the transmission data modulation unit 343 is set. The transmission data modulation unit 343 performs parallel conversion for the acquired transmission data and then modulates the transmission data.

The transmission unit 344 weights the transmission data modulated by the transmission data modulation unit 343 with a weight instructed by the control unit 342 and generates the base station downlink signal serving as the transmission signal to be transmitted from each antenna 350. The transmission unit 344 transmits each generated base station downlink signal from the antenna 350 by, for example, MIMO (step S213). The mobile relay station 300 repeats the processing from step S211.

Each antenna station 410 of the base station 400 receives the base station downlink signal from the mobile relay station 300 (step S221). Each antenna station 410 outputs, to the reception unit 420, the reception signal that is an electrical signal into which the received base station downlink signal has been converted. The reception unit 420 synchronizes timing of the reception signals received from the respective antenna stations 410. The reception unit 420 multiplies the reception signal received by each antenna station 410 by a weight and adds the reception signals. The base station signal reception processing unit 430 demodulates the added reception signal and decodes the demodulated reception signal. As a result, the base station signal reception processing unit 430 obtains the received waveform information (step S222). The base station signal reception processing unit 430 outputs the received waveform information to the terminal signal reception processing unit 440.

The terminal signal reception processing unit 440 performs reception processing for the terminal uplink signal indicated by the received waveform information (step S223). Specifically, the distribution unit 441 reads the waveform data having the same reception time from the received waveform information. The distribution unit 441 outputs the read waveform data and the antenna identification information of the waveform data to the signal processing unit 442. The signal processing unit 442 performs the frame detection (terminal signal detection), Doppler shift variation compensation, filtering, and offline beam control for the reception signal indicated by the waveform data output from the distribution unit 441. The signal processing unit 442 outputs the symbol of the reception signal to which the offline beam control has been applied to the terminal signal decoding unit 443. The terminal signal decoding unit 443 decodes the symbol input from the signal processing unit 442 to obtain the terminal transmission data transmitted from the terminal station 200. The base station 400 repeats the processing from step S221.

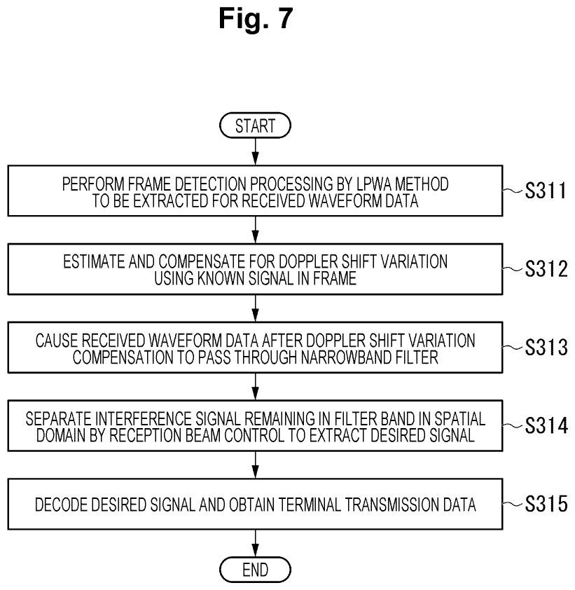

FIG. 7 is a flowchart illustrating processing of the signal processing unit 442 and the terminal signal decoding unit 443 of the base station 400. The processing illustrated in FIG. 7 is performed in the processing of step S223 in FIG. 6. The signal processing unit 442 and the terminal signal decoding unit 443 perform the processing illustrated in FIG. 7 for each desired signal. A correspondence between the reception time and the desired signal may be calculated in advance on the basis of the orbit information of the LEO satellite in which the mobile relay station 300 is mounted and the position of each terminal station 200.

The frame detection units 510-1 to 510-N of the signal processing unit 442 receive, as inputs, the waveform data of the reception antennas #1 to #N read by the distribution unit 441, respectively. The frame detection unit 510-n performs frame detection processing of detecting the LPWA frame to be extracted for the input received waveform data (step S311). The LPWA method for extraction is the LPWA method used for the desired signal. In the frame detection processing, the frame detection unit 510-n reads, from the storage unit inside or outside the frame detection unit 510-n, the plurality of transmission known signals to which different types of frequency shifts are respectively added or the plurality of transmission known signals to which combinations of different types of frequency shifts and different types of frequency variations are respectively added. These transmission known signals are known signals defined by the LPWA frame format to be extracted. The frame detection unit 510-n calculates the cross-correlation between each of the plurality of read transmission known signals and the reception signal waveform indicated by the waveform data of the reception antenna #n. The frame detection unit 510-n detects the frame section in the waveform data of the reception antenna #n on the basis of the position of the reception signal waveform from which the correlation value of the maximum or the threshold or more is obtained. The frame detection unit 510-n extracts the frame section detected from the waveform data of the reception antenna #n and outputs the frame section to the Doppler variation compensation unit 520-n.

The Doppler variation compensation unit 520-n estimates the Doppler shift variation of the frame section extracted by the frame detection unit 510-n by the above-described method A or method B using the known signal. The Doppler variation compensation unit 520-n performs compensation for canceling the estimated Doppler shift variation for the waveform data of the frame section (step S312). The Doppler variation compensation unit 520-n outputs the waveform data of the frame section in which the Doppler shift variation is compensated to the filter unit 530-n.

The filter unit 530-n performs narrowband filtering for the waveform data of the reception frame on which the Doppler variation compensation has been performed by the Doppler variation compensation unit 520-n (step S313). The pass bandwidth of the narrowband filtering is the same as the transmission signal bandwidth of the desired signal defined in an LPWA method to be extracted or a bandwidth obtained by adding a small margin. The filter unit 530-n outputs the narrowband signal extracted by the filtering to the reception beam control unit 540.

The reception beam control unit 540 performs the reception beam control by an adaptive array for each narrowband signal input from each of the filter units 530-1 to 530-N to separate the interference signal remaining in the filter band in the spatial domain and extract the desired signal (step S314). The reception beam control unit 540 outputs the extracted desired signal to the terminal signal decoding unit 443. The terminal signal decoding unit 443 performs the decoding processing for the desired signal input from the reception beam control unit 540 to obtain the terminal transmission data (step S315).

As described above, the signal processing unit 442 of the base station 400 narrows the band of the desired signal received by the mobile relay station 300 by the Doppler shift variation compensation. Therefore, the signal processing unit 442 can perform the reception beam control in a state where the influence of the interference signal is suppressed to the minimum by the narrowband filter. Therefore, the signal processing unit 442 can realize high signal separation performance.

### Second Embodiment

In the first embodiment, the Doppler shift variation is estimated and compensated using the known signal. However, the known signal such as a preamble is a signal sequence common to terminals of the same LPWA method. In a situation where the number of satellite IoT terminals and the number of ground IoT terminals increase year by year and the interference of respective signals occurs more frequently, estimation accuracy and compensation accuracy of the Doppler shift variation deteriorate due to an influence of the same known signal included in the interference signal, and it may be difficult to narrow a band of a desired signal. To suppress characteristic deterioration of narrowing a band of a desired signal due to Doppler shift variation compensation even in a situation where an interference is more frequent, in a second embodiment, a Doppler shift variation is compensated in a blind manner without using a known signal, and reception beam control is performed after narrowing the band of the desired signal. In the second embodiment, differences from the first embodiment will be mainly described.

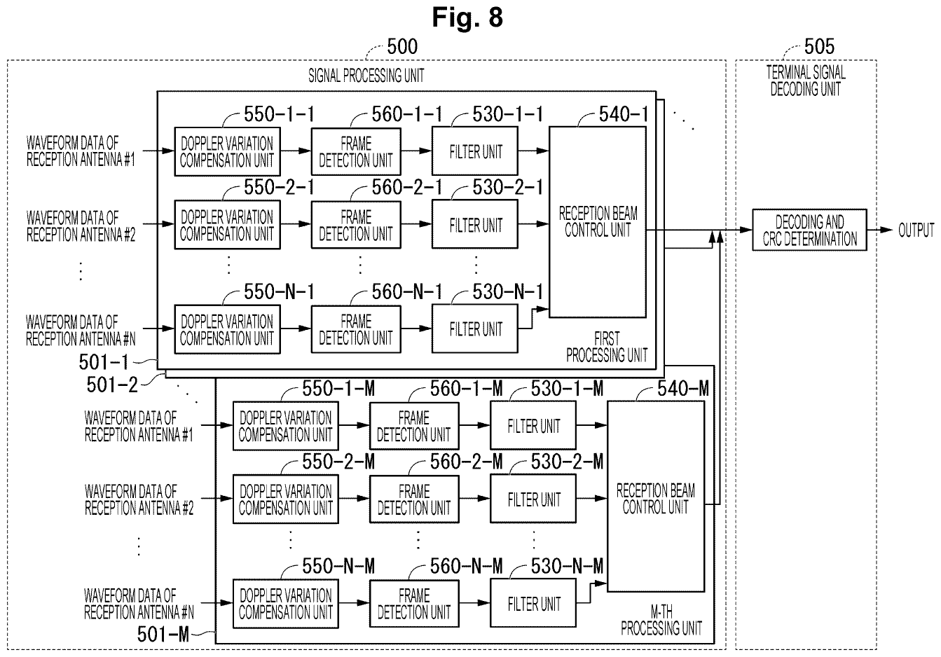

A configuration of a wireless communication system of the second embodiment is similar to that of the wireless communication system 100 of the first embodiment illustrated in FIG. 2. A configuration of a base station of the second embodiment is similar to that of the base station 400 of the first embodiment illustrated in FIG. 3 except for the following points. That is, a base station 400 of the second embodiment includes a signal processing unit 500 and a terminal signal decoding unit 505 illustrated in FIG. 8 instead of the signal processing unit 442 and the terminal signal decoding unit 443 of the first embodiment illustrated in FIG. 4.

FIG. 8 is a block diagram illustrating a configuration of the signal processing unit 500 of the second embodiment. The signal processing unit 500 includes a first processing unit 501-1 to an M-th processing unit 501-M, which are processing surfaces of M types of Doppler shift variation compensation of Δf₁(t), Δf₂(t), . . . , Δf_{M}(t). For example, it is assumed that the Doppler shift variation assumed on the basis of a terminal uplink signal frequency that is a frequency of a terminal uplink signal transmitted by a terminal station 200 and orbit altitude of a satellite in which a mobile relay station 300 is mounted for each time is −310 Hz/s to −50 Hz/s. In a case of dividing a range of 50 Hz/s to 310 Hz/s into M types at intervals of several Hz, the signal processing unit 500 provides the first processing unit 501-1 to the M-th processing unit 501-M that are the processing surfaces respectively corresponding to the M types of Doppler shift variations. A necessary step size varies depending on characteristics of an LPWA signal to be extracted, and is determined by a pre-system design. The first processing unit 501-1 to the M-th processing unit 501-M perform processing such as Doppler shift variation compensation, frame detection, filtering, and reception beam control for waveform data of reception antennas #1 to #N. Note that description of reception processing performed by other general wireless communication apparatuses performed by the signal processing unit 500 will be omitted.

The terminal signal decoding unit 505 performs decoding processing for an output of the reception beam control in each of the M processing surfaces of the first processing unit 501-1 to the M-th processing unit 501-M. The terminal signal decoding unit 505 outputs a decoding result of the processing surface that has been successfully decoded as a processing result in the functional unit. For example, in a case where a determination result of cyclic redundancy check (CRC) is OK, the terminal signal decoding unit 505 determines that the decoding has succeeded.

The m-th processing unit 501-m (m is an integer from 1 to M, both inclusive) includes Doppler variation compensation units 550-1-m to 550-N-m, frame detection units 560-1-m to 560-N-m, filter units 530-1-m to 530-N-m, and a reception beam control unit 540-m.

The Doppler variation compensation unit 550-n-m (n is an integer from 1 to N, both inclusive) on the m-th processing surface adds a frequency variation of Δfₘ(t) to the waveform data of the reception antenna #n. The frame detection unit 560-n-m receives, as an input, the waveform data of the reception antenna #n to which the frequency variation of Δfₘ(t) is added by the Doppler variation compensation unit 550-n-m. The frame detection unit 560-n-m performs processing similar to the frame detection unit 510-n in the first embodiment, and detects a section including a terminal transmission frame from the input waveform data and extracts a detected frame section. That is, the frame detection unit 560-n-m calculates cross-correlation between a plurality of transmission known signals to which different types of frequency shifts are respectively added and a reception signal waveform indicated by the waveform data to which the frequency variation is added. The frame detection unit 560-n-m searches for the transmission known signal in which a correlation value of the cross-correlation is maximum or a threshold or more, and detects, for example, a head position of a reception frame on the basis of a position of a received waveform from which the correlation value is obtained. When detecting the head position of the reception frame, the frame detection unit 560-n-m extracts a section of a frame length defined by a frame format from the waveform data, or specifies an end position of the frame on the basis of information of the frame length described in a header in the reception frame and extracts the frame section. Note that the frequency shift added to the searched transmission known signal is substantially the same as the Doppler shift received by the terminal uplink signal of the desired signal, similarly to the first embodiment. Therefore, the Doppler shift compensation may be performed for the waveform data, using the frequency shift added to the searched transmission known signal as an estimation value of the Doppler shift. Alternatively, the frame detection unit 560-n-m may use a generally used method such as detecting a section in which a time domain waveform is equal to or greater than a certain amplitude as a section including the frame transmitted by the terminal station 200.

Similarly to the filter unit 530-n of the first embodiment illustrated in FIG. 4, the filter unit 530-n-m performs filtering for limiting a band using a narrowband filter for the waveform data of the reception frame extracted by the frame detection unit 560-n-m. The reception beam control unit 540-m receives, as an input, a narrowband signal in a peripheral band of the desired signal extracted by each of the filter units 530-1-m to 530-N-m. The reception beam control unit 540-m performs reception beam control by an adaptive array similarly to the reception beam control unit 540 of the first embodiment illustrated in FIG. 4 using the input narrowband signals. The reception beam control unit 540-m outputs the reception signal obtained by separating the interference signal by the reception beam control to the terminal signal decoding unit 505.

The terminal signal decoding unit 505 decodes the reception signal input from each of the first processing unit 501-1 to the M-th processing unit 501-M, and performs CRC determination for a decoding result. The terminal signal decoding unit 505 outputs the decoding result determined to be successful by the CRC determination.

Operation of the wireless communication system 100 of the second embodiment will be described. The wireless communication system 100 of the second embodiment performs processing similar to the processing of the wireless communication system 100 of the first embodiment illustrated in FIGS. 5 and 6.

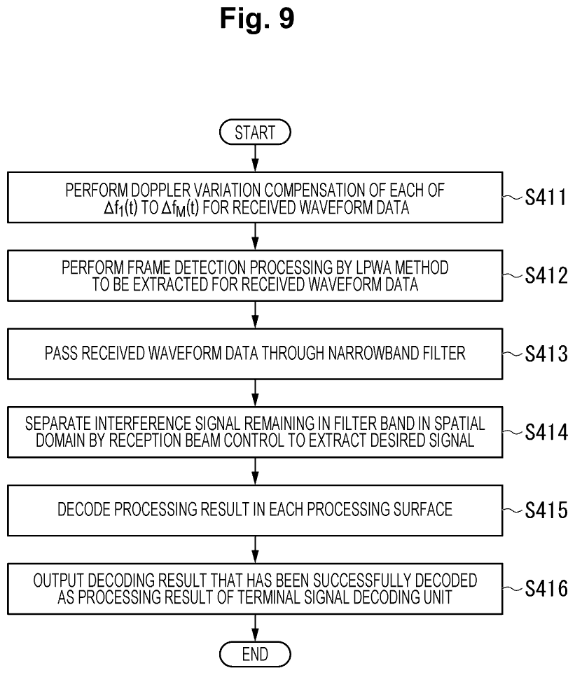

FIG. 9 is a flowchart illustrating processing of the signal processing unit 500 and the terminal signal decoding unit 505 according to the second embodiment. The processing illustrated in FIG. 9 is performed in the processing of step S223 in FIG. 6. The signal processing unit 500 and the terminal signal decoding unit 505 perform the processing illustrated in FIG. 9 for each desired signal.

The signal processing unit 500 inputs the waveform data of the reception antennas #1 to #N to the first processing unit 501-1 to the M-th processing unit 501-M. The first processing unit 501-1 to the M-th processing unit 501-M respectively perform the variation compensation of the Doppler shifts of Δf₁(t), Δf₂(t), . . . , Δf_{M}(t) for the input waveform data (step S411). That is, the Doppler variation compensation unit 550-n-m of the signal processing unit 500-m adds the frequency variation of Δfₘ(t) to the waveform data of the reception antenna #n.

The first processing unit 501-1 to the M-th processing unit 501-M perform the frame detection processing of detecting an LPWA frame to be extracted for the waveform data of the reception antennas #1 to #N on which the variation compensation of the Doppler shift has been performed (step S412). That is, the frame detection unit 560-n-m receives, as an input, the waveform data of the reception antenna #n to which the frequency variation of Δfₘ(t) is added from the Doppler variation compensation unit 550-n-m. The frame detection unit 560-n-m reads a plurality of transmission known signals to which different types of frequency shifts are respectively added from a storage unit inside or outside the frame detection unit 560-n-m. These transmission known signals are known signals defined by the LPWA frame format to be extracted. The frame detection unit 560-n-m calculates cross-correlation between each of the plurality of read transmission known signals and the reception signal waveform indicated by the input waveform data of the reception antenna #n. The frame detection unit 560-n-m detects the frame section in the input waveform data on the basis of the position of the reception signal waveform from which the correlation value of the maximum or the threshold or more is obtained. The frame detection unit 560-n-m extracts the frame section detected by the frame detection from the input waveform data, and outputs the frame section to the filter unit 530-n-m.

Each of the first processing unit 501-1 to the M-th processing unit 501-M performs narrowband filtering for received waveform data of the detected frame (step S413). That is, the filter unit 530-n-m performs the narrowband filtering in which a bandwidth that is the same as a transmission signal bandwidth of the desired signal or a bandwidth obtained by adding a small margin is a pass bandwidth, for wavelength data of the frame section extracted by the frame detection unit 560-n-m. The filter unit 530-n-m outputs the narrowband signal extracted by the filtering to the reception beam control unit 540-m.

Each of the first processing unit 501-1 to the M-th processing unit 501-M performs the reception beam control for the narrowband signal obtained by filtering. That is, the reception beam control unit 540-m performs the reception beam control by an adaptive array for the narrowband signal input from each of the filter units 530-1-m to 530-N-m to separate the interference signal remaining in a filter band in a spatial domain and extract the desired signal (step S414). The reception beam control unit 540-m outputs the extracted desired signal to the terminal signal decoding unit 505.

The terminal signal decoding unit 505 performs the decoding processing for the desired signals respectively input from the reception beam control units 540-1 to 540-M of the first processing unit 501-1 to the M-th processing unit 501-M (step S415). The terminal signal decoding unit 505 performs the CRC determination for the decoding results of the desired signals input from the M processing surfaces of the first processing unit 501-1 to the M-th processing unit 501-M. When the CRC determination result is OK, the terminal signal decoding unit 505 determines that the decoding has succeeded. The terminal signal decoding unit 505 outputs the decoding result of the processing surface that has been successfully decoded as a processing result (step S416).

Note that the signal processing unit 500 may perform subsequent processing only for the processing surface on which the cross-correlation value of the frame detection is equal to or greater than the threshold. That is, the frame detection unit 560-n-m determines whether one or more of the cross-correlation values calculated when the frame detection units 560-1-m to 560-N-m respectively perform the frame detection processing for the waveform data of the reception antennas #1 to #M are equal to or greater than a preset threshold. In a case where there is the cross-correlation value equal to or greater than the threshold, the frame detection unit 560-n-m outputs a frame detection result to the subsequent filter unit 530-n-m. On the other hand, in a case where there is no cross-correlation value equal to or greater than the threshold, the frame detection unit 560-n-m discards the waveform data without inputting the waveform data to the filter unit 530-n-m. The other processing is the same as that of the signal processing unit 500 described above. As a result, a calculation amount can be reduced as compared with the signal processing unit 500 in the basic mode.

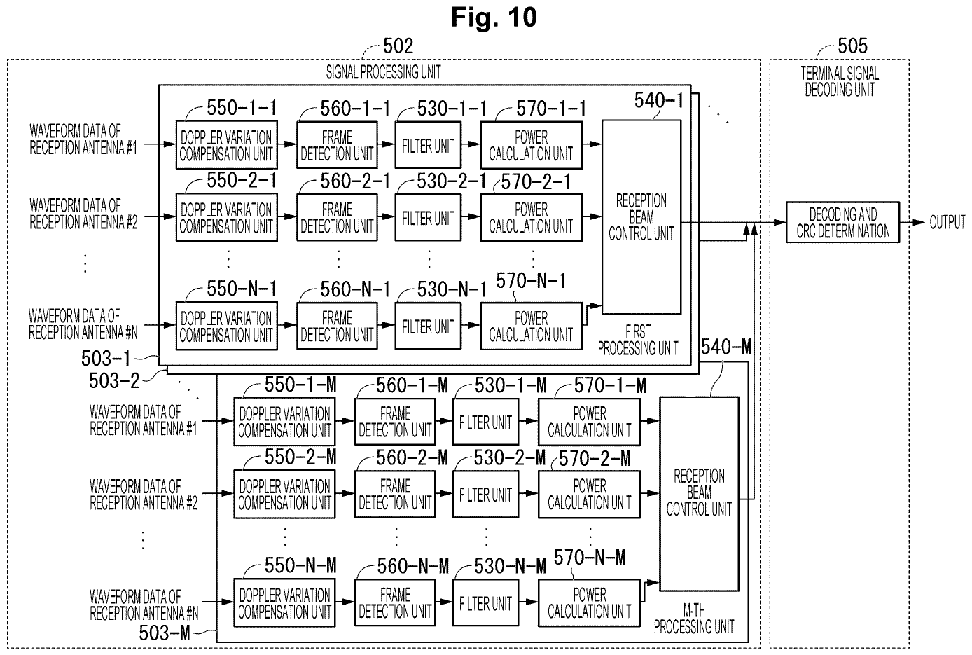

Further, as illustrated in FIG. 10, the subsequent processing may be performed only for the processing surface on which power in the filter band after filtering is equal to or greater than a threshold.

FIG. 10 is a diagram illustrating a configuration of the signal processing unit 502 according to a modification of the second embodiment. In FIG. 10, the same portions as those of the signal processing unit 501 illustrated in FIG. 8 are denoted by the same reference numerals, and description thereof will be omitted. The signal processing unit 502 includes a first processing unit 503-1 to an M-th processing unit 503-M, which are processing surfaces of M types of Doppler shift variation compensation of Δf₁(t), Δf₂(t), . . . , Δf_{M}(t). The m-th processing unit 503-m is different from the m-th processing unit 501-m illustrated in FIG. 8 in further including power calculation units 570-1-m to 570-N-m.

The power calculation unit 570-n-m receives, as an input, the narrowband signal of the narrowband filtered antenna #n from the filter unit 530-n-m. The power calculation unit 570-n-m calculates the power of the input waveform data. The power calculation unit 570-n-m determines whether one or more of the pieces of the power of the narrowband signals of the reception antennas #1 to #N calculated by the power calculation units 570-1-m to 570-N-m are equal to or greater than a preset threshold. In a case where there is the power equal to or greater than the threshold, the power calculation unit 570-n-m outputs the narrowband signal input from the filter unit 530-n-m to the reception beam control unit 540-m. On the other hand, in a case where there is no power equal to or greater than the threshold, the power calculation unit 570-n-m discards the narrowband signal without inputting the narrowband signal to the reception beam control unit 540-m.

Alternatively, the power calculation units 570-1-m to 570-N-m may output the narrowband signal and information of the calculated power to the reception beam control unit 540-m. The reception beam control unit 540-m performs the reception beam control in a case where one or more of the input power information is equal to or greater than a preset threshold. The reception beam control unit 540-m may discard the narrowband signal without performing the reception beam control in a case where none of the pieces of input power information is less than the threshold.

The other processing is the same as that of the signal processing unit 500 described above. As a result, a calculation amount can be reduced as compared with the signal processing unit 500 in the basic mode.

According to the present embodiment, it is possible to realize the reception beam control with good signal separation performance even in a situation where an interference frequently occurs.

### Third Embodiment

Although the frequency conversion of the terminal uplink signal is performed in the mobile relay station in the first and second embodiments, the frequency conversion may be performed in the base station. In a third embodiment, a wireless communication system that performs frequency conversion in a base station will be described focusing on a difference from the above-described first and second embodiments.

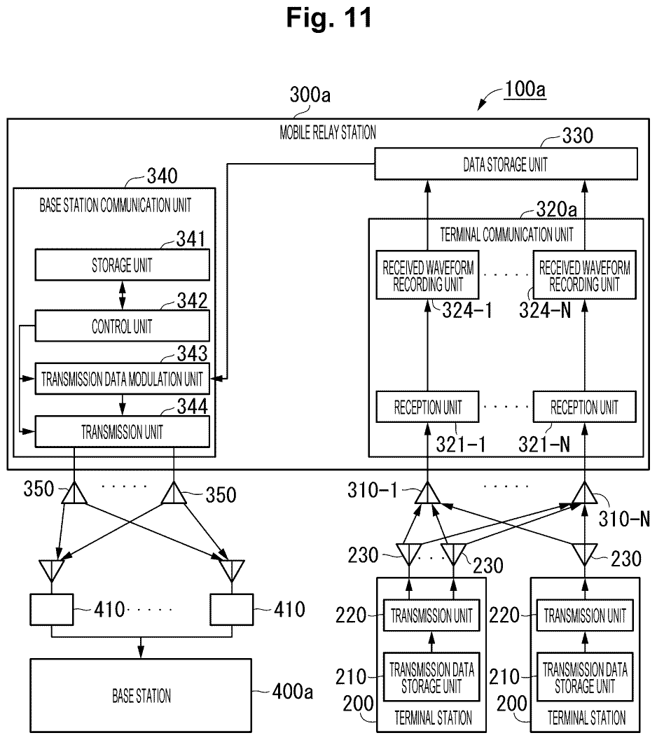

FIG. 11 is a diagram illustrating a configuration of a wireless communication system 100a according to the third embodiment. In FIG. 11, the same parts as those in the wireless communication system 100 according to the first embodiment in FIG. 2 will be denoted by the same reference signs, and description thereof will be omitted. The wireless communication system 100a includes a terminal station 200, a mobile relay station 300a, and a base station 400a.

The mobile relay station 300a illustrated in FIG. 11 is different from the mobile relay station 300 illustrated in FIG. 2 in including a terminal communication unit 320a instead of the terminal communication unit 320. The terminal communication unit 320a includes N reception units 321 and N received waveform recording units 324. The received waveform recording unit 324 connected with a reception unit 321-n will be referred to as a received waveform recording unit 324-n. The received waveform recording unit 324-n samples a received waveform of a terminal uplink signal received by the reception unit 321-n as an RF signal, and generates waveform data indicating a value obtained by the sampling. The received waveform recording unit 324-n writes, to a data storage unit 330, received waveform information in which antenna identification information of an antenna 310-n, reception time of the terminal uplink signal in the antenna 310-n, and the generated waveform data are set.

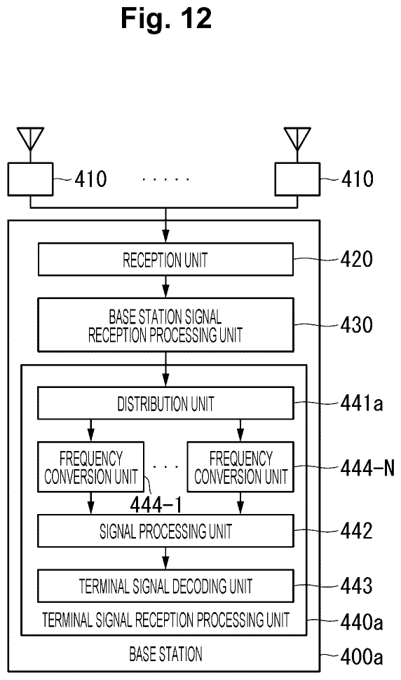

FIG. 12 is a diagram illustrating a configuration of the base station 400a. In FIG. 12, the same portions as those of the base station 400 illustrated in FIG. 3 are denoted by the same reference numerals, and description thereof will be omitted. The base station 400a illustrated in FIG. 12 is different from the base station 400 illustrated in FIG. 3 in including a terminal signal reception processing unit 440a instead of the terminal signal reception processing unit 440. The terminal signal reception processing unit 440a includes a distribution unit 441a, N frequency conversion units 444, a signal processing unit 442, and a terminal signal decoding unit 443. The N frequency conversion units 444 are referred to as frequency conversion units 444-1 to 444-N, respectively.

The distribution unit 441a reads the waveform data of the same reception time from the received waveform information, and outputs the read waveform data to the frequency conversion units 444-1 to 444-N according to the antenna identification information associated with the waveform data. That is, the distribution unit 441a outputs the waveform data of the reception antenna #n to the frequency conversion unit 444-n. The waveform data of the reception antenna #n is waveform data associated with the antenna identification information of the antenna 310-n. The frequency conversion unit 444-n frequency-converts a signal indicated by the input waveform data of the reception antenna #n from the RF signal into a baseband signal. The frequency conversion is performed by using a quadrature demodulator or the like. Each of the frequency conversion units 444-1 to 444-N outputs the frequency-converted signal to the signal processing unit 442.

The wireless communication system 100a of the third embodiment performs processing similar to the processing of the wireless communication system 100 of the first embodiment illustrated in FIGS. 5 and 6 except for the following points. That is, in step S122 in FIG. 5, the received waveform recording unit 324-n of the mobile relay station 300a writes, in the data storage unit 330, the received waveform information in which the waveform data representing the waveform of the terminal uplink signal received by the reception unit 321-n, the reception time, and the antenna identification information of the antenna 310-n are associated with each other. Furthermore, in step S223 of FIG. 6, the distribution unit 441a reads the waveform data having the same reception time from the received waveform information. The distribution unit 441a outputs the read waveform data to the frequency conversion units 444-1 to 444-N according to the antenna identification information associated with the waveform data. The frequency conversion unit 444-n frequency-converts a reception signal represented by the waveform data of the antenna #n from the RF signal to the baseband signal. The frequency conversion unit 444-n outputs the frequency-converted reception signal to the signal processing unit 442. Processing after the reception signals of the antennas #1 to #N are input from the respective frequency conversion units 444-1 to 444-N to the signal processing unit 442 is similar to that in the above-described first embodiment.

The signal processing unit 442 performs the processing of the first embodiment illustrated in FIG. 7 using the reception signals of the antennas #1 to #N respectively input from the frequency conversion units 444-1 to 444-N. Alternatively, in a case where the mobile relay station 300a includes the signal processing unit 500 and the terminal signal decoding unit 505 of the second embodiment illustrated in FIG. 8 or the signal processing unit 502 and the terminal signal decoding unit 505 of the second embodiment illustrated in FIG. 10, instead of the signal processing unit 442 and the terminal signal decoding unit 443, the signal processing unit 500 and the signal processing unit 502 perform the processing of the second embodiment using the reception signals of the antennas #1 to #N respectively input from the frequency conversion units 444-1 to 444-N.

### Fourth Embodiment

In the above-described first to third embodiments, decoding of the terminal uplink signal is performed in the base station. In the present embodiment, decoding of a terminal uplink signal is performed in a mobile relay station. The present embodiment will be described focusing on a difference from the first to third embodiments.

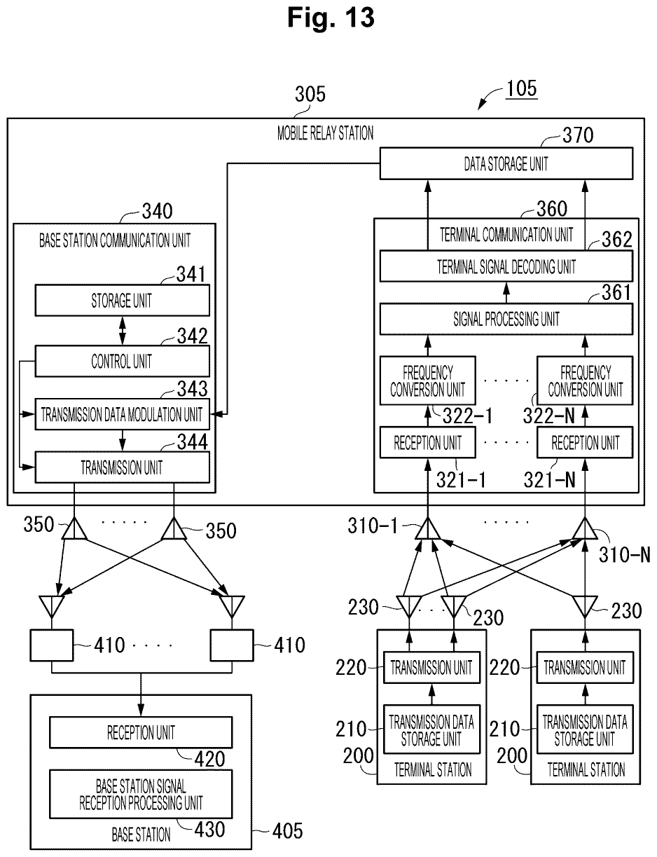

FIG. 13 is a configuration diagram of a wireless communication system 105 according to a fourth embodiment. In the drawing, the same components as those of the wireless communication system 100 according to the first embodiment illustrated in FIG. 2 are denoted by the same reference numerals, and description thereof will be omitted. The wireless communication system 105 includes a terminal station 200, a mobile relay station 305, and a base station 405. The mobile relay station 305 is an example of a signal processing apparatus.

The mobile relay station 305 includes antennas 310-1 to 310-N (N is an integer of 2 or more), a terminal communication unit 360, a data storage unit 370, a base station communication unit 340, and M (M is an integer of 1 or more) antennas 350.

The terminal communication unit 360 includes reception units 321-1 to 321-N, frequency conversion units 322-1 to 322-N, a signal processing unit 361, and a terminal signal decoding unit 362. The signal processing unit 361 and the terminal signal decoding unit 362 have functions similar to those of the signal processing unit 442 and the terminal signal decoding unit 443 of the first embodiment illustrated in FIG. 4, the signal processing unit 500 and the terminal signal decoding unit 505 of the second embodiment illustrated in FIG. 8, or the signal processing unit 502 and the terminal signal decoding unit 505 of the second embodiment illustrated in FIG. 10, respectively. The terminal signal decoding unit 362 writes terminal transmission data obtained as a decoding result in the data storage unit 370. The data storage unit 370 stores the terminal transmission data transmitted by each terminal station 200. The transmission data modulation unit 343 of the base station communication unit 340 reads terminal transmission data from the data storage unit 370 as transmission data.

The base station 405 includes one or more antenna stations 410, a reception unit 420, and a base station signal reception processing unit 430. The base station signal reception processing unit 430 demodulates and decodes a reception signal combined in the reception unit 420 to obtain the terminal transmission data.

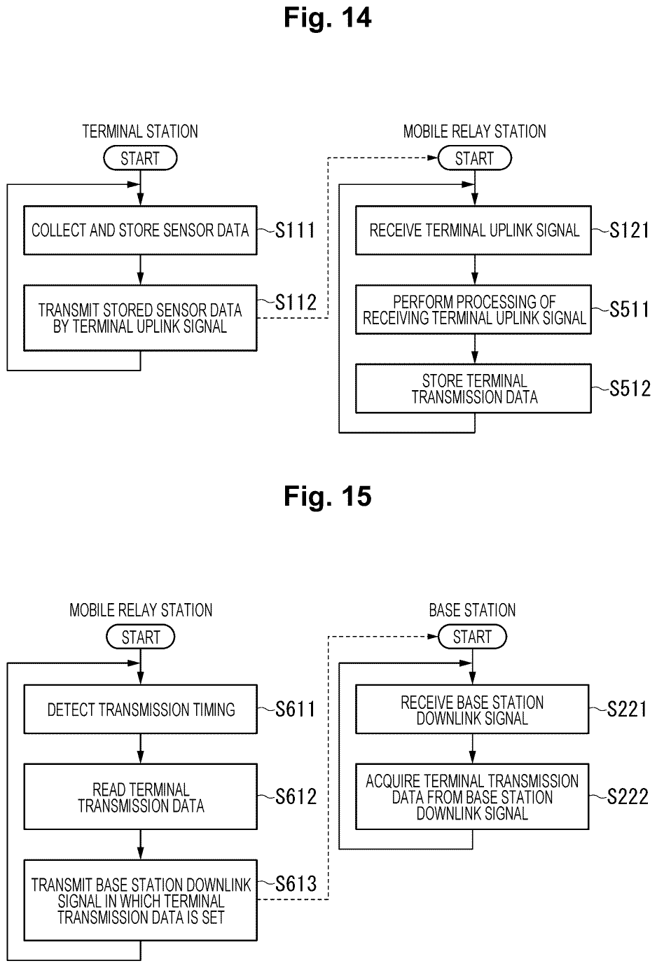

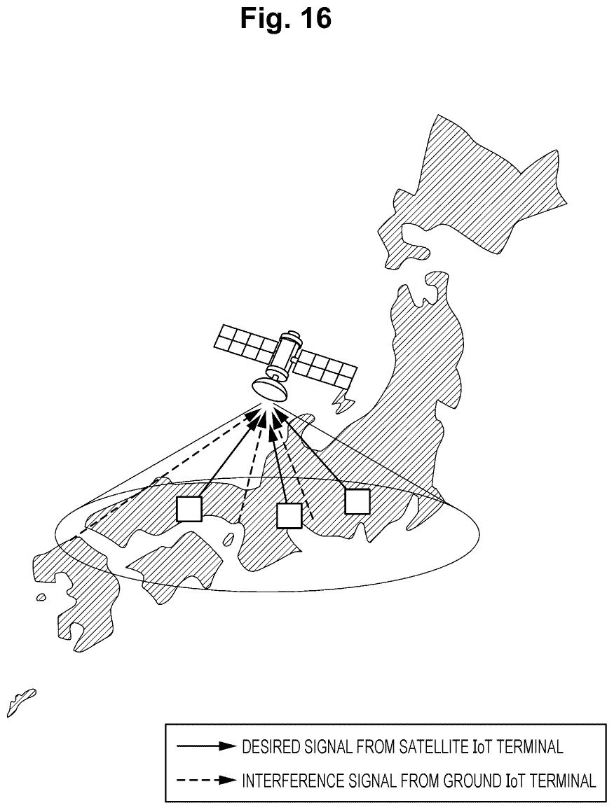

Operation of the wireless communication system 105 will be described. FIG. 14 is a flowchart illustrating processing of the wireless communication system 105 in a case where an uplink signal is transmitted from the terminal station 200. In FIG. 14, the same processing as that illustrated in the flowchart of the first embodiment illustrated in FIG. 5 is denoted by the same reference numerals.

Processing of the terminal station 200 in steps S111 and S112 is similar to that of the first embodiment illustrated in FIG. 5. Processing of the mobile relay station 305 in step S121 is similar to that of the first embodiment illustrated in FIG. 5. That is, the reception units 321-1 to 321-N of the mobile relay station 305 receive the terminal uplink signal transmitted from the terminal station 200 (step S121). The frequency conversion units 322-n performs frequency conversion for the terminal uplink signal of a reception antenna #n received by the reception unit 321-n from an RF signal to a baseband signal. The signal processing unit 361 receives, as inputs, the terminal uplink signals of the reception antennas #1 to #N that are respectively frequency-converted into baseband signals from the frequency conversion units 322-1 to 322-N.

The signal processing unit 361 performs reception processing for the terminal uplink signals of the reception antennas #1 to #N respectively input from the frequency conversion units 322-1 to 322-N. The terminal signal decoding unit 362 decodes a symbol received and processed by the signal processing unit 361 to obtain the terminal transmission data transmitted from terminal station 200 (step S511). The terminal signal decoding unit 362 writes the terminal transmission data obtained by the decoding in the data storage unit 370 (step S512).

In step S511, the signal processing unit 361 and the terminal signal decoding unit 362 perform the same processing as the signal processing unit 442 and the terminal signal decoding unit 443 of the first embodiment illustrated in FIG. 7 for each desired signal by using the terminal uplink signals of the reception antennas #1 to #N. Alternatively, in step S511, the signal processing unit 361 and the terminal signal decoding unit 362 perform the same processing as the signal processing unit 500 and the terminal signal decoding unit 505 of the second embodiment illustrated in FIG. 9 or the same processing as the signal processing unit 502 and the terminal signal decoding unit 505 of the second embodiment for each desired signal by using the terminal uplink signals of the reception antennas #1 to #N.

FIG. 15 is a flowchart illustrating processing of the wireless communication system 105 in a case where a base station downlink signal is transmitted from the mobile relay station 305. In FIG. 15, the same processing as that illustrated in the flowchart of the first embodiment illustrated in FIG. 6 is denoted by the same reference numerals.

The mobile relay station 305 performs processing similar to that in steps S211 to S213 in FIG. 5 (steps S611 to S613). Note that, in step S611, the control unit 342 instructs the transmission data modulation unit 343 and the transmission unit 344 to transmit the terminal transmission data. Further, in step S612, the transmission data modulation unit 343 reads the terminal transmission data accumulated in the data storage unit 370 as transmission data. In step S613, the transmission unit 344 transmits the base station downlink signal in which the terminal transmission data is set from the antenna 350. The mobile relay station 305 repeats the processing from step S611.

As in the first embodiment, the base station 405 receives the base station downlink signal from the mobile relay station 305 (step S221). The reception unit 420 synchronizes timing of the reception signals received from the respective antenna stations 410. The reception unit 420 multiplies the reception signal received by each antenna station 410 by a weight and adds the reception signals. The base station signal reception processing unit 430 demodulates the added reception signal and decodes the demodulated reception signal to obtain the terminal transmission data (step S621). The base station 405 repeats the processing from step S221.

In the above-described present embodiments, the cases where the mobile relay station 300 and the base station 400, the mobile relay station 300a and the base station 400a, and the mobile relay station 305 and the base station 405 perform communication by MIMO have been described as examples, but the present invention is not limited thereto. For example, the mobile relay station 300, 300a, or 305 may transmit the base station downlink signal to the base station 400, 400a, or 405 via one antenna 350. Similarly, the base station 400, 400a, or 405 may receive the base station downlink signal from the mobile relay station 300, 300a, or 305 by one antenna station or one antenna instead of the plurality of antenna stations 410.

In the above-described embodiments, the case where the mobile object on which the mobile relay station is mounted is an LEO satellite has been described. However, the mobile object may be another flying object that flies through the sky, such as a geostationary satellite, a drone, or a HAPS. Further, the above embodiments are also applicable to a case where a relay station that does not move receives a wireless signal from a terminal station that moves on a predetermined orbit, for example.

According to the above-described embodiments, it is possible to realize the reception beam control capable of achieving sufficient signal separation performance even in the satellite IoT-PF having a large Doppler shift variation.

All or some of the functions of the signal processing unit 442 and the terminal signal decoding unit 443 of the base stations 400 and 400a and the signal processing unit 361 and the terminal signal decoding unit 362 of the mobile relay station 305 may be realized by a processor such as a central processing unit (CPU) or a graphics processing unit (GPU) reading and executing a program from a storage unit. Further, all or some of the functions of the signal processing unit 442 and the terminal signal decoding unit 443 of the base stations 400 and 400a and the signal processing unit 361 and the terminal signal decoding unit 362 of the mobile relay station 305 may be realized by using hardware such as an application specific integrated circuit (ASIC), a programmable logic device (PLD), or a field programmable gate array (FPGA).

According to the above-described embodiments, a signal processing apparatus includes a Doppler variation compensation unit, a filter unit, and a reception beam control unit. For example, the signal processing apparatus is the base station 400 or 400a or the mobile relay station 305 in the embodiments. The Doppler variation compensation unit compensates for a Doppler shift variation that is a time variation of a Doppler shift with respect to waveform data indicating a waveform of a wireless signal received by a communication apparatus using each of a plurality of antennas. For example, the communication apparatus is the mobile relay station 300 or 300a, or 305 of the embodiments. The filter unit extracts the narrowband signal that is the signal having the bandwidth equivalent to the bandwidth of the desired signal or the bandwidth obtained by adding a predetermined margin to the bandwidth of the desired signal from the signal indicated by each of the plurality of pieces of waveform data in which the Doppler shift is compensated. The reception beam control unit performs the reception beam control using an adaptive array for the plurality of the narrowband signals extracted by the filter unit.

The Doppler variation compensation unit may estimate the Doppler shift variation on the basis of the phase rotation amount of the known signal section in the signal frame included in the waveform data. The Doppler variation compensation unit compensates for the Doppler shift variation by adding the phase rotation that cancels the estimated Doppler shift variation over the section of the signal frame included in the waveform data.

The Doppler variation compensation unit may calculate the cross-correlation between the waveform data and the transmission known signal that is the known signal to which each of a plurality of types of frequency variations is added. The frequency variation corresponds to the Doppler shift variation assumed from the terminal uplink signal frequency and the satellite orbital altitude. The Doppler variation compensation unit compensates for the Doppler shift variation by adding the phase rotation that cancels the frequency variation added to the transmission known signal in which the correlation value obtained as a result of the calculation is the maximum or the threshold or more over the section of the signal frame included in the waveform data.

The signal processing apparatus may further include a frame detection unit. The frame detection unit is, for example, the frame detection units 510-1 to 510-N of the embodiments. The frame detection unit detects the signal frame included in the waveform data on the basis of the result of calculating the cross-correlation between the waveform data of each of the plurality of antennas and each of the known signals to which different types of frequency shifts are added or each of known signals to which different types of frequency shifts and different types of frequency variations are added, and extracts the section of the detected signal frame from the waveform data. The Doppler variation compensation unit compensates for the Doppler shift variation for each piece of the waveform data extracted by the frame detection unit.

The signal processing apparatus includes a plurality of processing units and a decoding unit. The plurality of processing units is, for example, the first processing unit 501-1 to the M-th processing unit 501-M and the first processing unit 503-1 to the M-th processing unit 503-M of the embodiments. Each processing unit includes a Doppler variation compensation unit, a filter unit, and a reception beam control unit. The decoding unit decodes the reception signal. Each of the plurality of processing units corresponds to the plurality of different types of Doppler shift variations. The plurality of types of frequency variations is, for example, frequency variations at predetermined intervals that cancel the assumed range of the Doppler shift variation. The Doppler variation compensation unit included in the processing unit compensates for the Doppler shift variation corresponding to the processing unit for the waveform data of each of the plurality of antennas. The decoding unit decodes the reception signal obtained by the reception beam control unit of each of the plurality of processing units performing the reception beam control, and outputs the decoding result of successful decoding.

Each processing unit may further include a frame detection unit. The frame detection unit is, for example, the frame detection units 560-1-1 to 560-N-M of the embodiments. The frame detection unit detects the signal frame included in the waveform data on the basis of the result of calculating the cross-correlation between the waveform data in which the Doppler variation compensation unit has compensated for the Doppler shift variation and each of the known signals to which different types of frequency shift has been added, extracts the section of the detected signal frame from the waveform data, and outputs the section to the filter unit. In a case where one or more of the correlation values obtained as a result of calculating the cross-correlation in the frame detection unit included in the processing unit are equal to or greater than the threshold, each processing unit may perform the processing of the filter unit and the reception beam control unit included in the processing unit.

Each processing unit may perform the processing of the reception beam control unit included in the processing unit in a case where the signal power of at least one of the plurality of narrowband signals extracted by the filter unit included in the processing unit is equal to or greater than the threshold.

In addition, at least some functions of the signal processing apparatus may be realized by a computer. In that case, a program for realizing the functions of the signal processing apparatus may be recorded in a computer-readable recording medium, and the functions may be realized by loading the program recorded in this recording medium to a computer system, and executing the program. The computer system includes, for example, a processor and hardware such as an OS and peripheral devices. The program of the signal processing apparatus may be recorded on a computer-readable recording medium. The computer-readable recording medium is, for example, a portable medium such as a flexible disk, a magneto-optical disc, a ROM, or a CD-ROM or a storage device such as a hard disk built in a computer system. The program of the signal processing apparatus may be transmitted via a telecommunication line.

Although the embodiments of the present invention have been described above in detail with reference to the drawings, the specific configuration is not limited to the embodiments, and includes design and the like within a range not departing from the gist of the present invention.

### REFERENCE SIGNS LIST

1, 100, 100a, 105 Wireless communication system
2, 200 Terminal station
3, 300, 300a, 305 Mobile relay station
4, 400, 400a, 405 Base station
21 Transmission data storage unit
22 Transmission unit
31-1 to 31-N Reception unit
32-1 to 32-N Waveform sampling unit
34 Base station communication unit
41 Base station reception unit
42 Signal processing unit
210 Transmission data storage unit
220 Transmission unit
230 Antenna
310-1 to 310-N, 350 Antenna
320, 320a Terminal communication unit
321-1 to 321-N Reception unit
322-1 to 322-N Frequency conversion unit
323-1 to 323-N, 324-1 to 324-N Received waveform recording unit
330 Data storage unit
340 Base station communication unit
341 Storage unit
342 Control unit
343 Transmission data modulation unit
344 Transmission unit
360 Terminal communication unit
361 Signal processing unit
362 Terminal signal decoding unit
370 Data storage unit
400 Base station
410 Antenna station
420 Reception unit
430 Base station signal reception processing unit
440, 440a Terminal signal reception processing unit
441, 441a Distribution unit
442 Signal processing unit
443 Terminal signal decoding unit
444-1 to 444-N Frequency conversion unit
500, 502 Signal processing unit
501-1, 503-1 First processing unit
501-2, 503-2 Second processing unit
501-M, 503-M M-th processing unit
505 Terminal signal decoding unit
510-1 to 510-N Frame detection unit
520-1 to 520-N, 550-1-1 to 550-N-M Doppler variation compensation unit
530-1 to 530-M, 530-1-1 to 530-N-M Filter unit
540, 540-1 to 540-M Reception beam control unit
560-1-1 to 560-N-M Frame detection unit
570-1-1 to 570-N-M Power calculation unit

1. A signal processing apparatus comprising:
a plurality of Doppler variation compensation circuitries coupled to respective antennas included in a plurality of antennas of a communication apparatus, each compensating for a Doppler shift variation that is a time variation of a Doppler shift with respect to one of a plurality of pieces of waveform data indicating a waveform of a wireless signal having been received by one of the respective antennas of the plurality of antennas;
a plurality of filters coupled to respective one of the plurality of Doppler variation compensation circuitries, each extracting one of a plurality of narrowband signals having a bandwidth equivalent to a bandwidth of a desired signal or a bandwidth obtained by adding a predetermined margin to the bandwidth of the desired signal from one of the plurality of pieces of waveform data in which the Doppler shift variation has been compensated by one of the respective ones of the plurality of Doppler variation compensation circuitries; and
a reception beam controller, performing reception beam control by an adaptive array for the plurality of narrowband signals having been extracted by the plurality of filters.

2. The signal processing apparatus according to claim 1, wherein
each of the plurality of Doppler variation compensation circuitries estimates a Doppler shift variation on a basis of a phase rotation amount of a known signal section in a signal frame included in the one of the plurality of pieces of waveform data, and compensates for the Doppler shift variation by adding a phase rotation that cancels the estimated Doppler shift variation over a section of the signal frame included in the one of the plurality of pieces of waveform data.

3. The signal processing apparatus according to claim 1, wherein
each of the plurality of Doppler variation compensation circuitries calculates cross-correlation between each of a plurality of transmission known signals to which a plurality of types of frequency variations are added, and the one of the plurality of pieces of waveform data, and compensates for the Doppler shift variation by adding a phase rotation that cancels a frequency variation added to one of the plurality of transmission known signals in which a correlation value obtained as a result of the calculation is a maximum or a threshold or more over a section of a signal frame included in the one of the plurality of pieces of waveform data.

4. The signal processing apparatus according to claim 1, further comprising:
a plurality of frame detectors coupled to the respective antennas of the plurality of antennas of a communication apparatus, each detecting a signal frame included in one of the plurality of pieces of waveform data received by one of the respective antennas of the plurality of antennas on a basis of a result of calculating cross-correlation between the one of the plurality of pieces of waveform data and each of known signals to which different types of frequency shifts are added or each of known signals to which different types of frequency shifts and different types of frequency variations are added, and extracting a section of the detected signal frame from the one of the plurality of pieces of waveform data, wherein
each of the Doppler variation compensation circuitries compensates for a Doppler shift variation for the section having been extracted the one of the plurality of piece of waveform data.

5. The signal processing apparatus according to claim 1, wherein
the signal processing apparatus includes
a plurality of processing circuitries, each including the plurality of the Doppler variation compensation circuitries, the plurality of filters, and the reception beam controller, and
a decoder decoding a reception signal, and wherein
the plurality of processing circuitries are provided for coping with a plurality of different types of Doppler shift variations, respectively,
each of the plurality of Doppler variation compensation circuitries included in each of the plurality of processing circuitries compensates the Doppler shift variation assigned to the each of the plurality of processing circuitries for the one of the plurality of pieces of waveform data, and
the decoder decodes the reception signals each having been obtained by the reception beam control performed by the reception beam controller of each of the plurality of processing circuitries, and outputs a decoding result of successful decoding.

6. The signal processing apparatus according to claim 5, wherein
each of the plurality of processing circuitries further includes a plurality of frame detectors coupled to the respective antennas of the plurality of antennas of a communication apparatus, each detecting a signal frame included in one of the plurality of pieces of waveform data received by one of the respective antennas of the plurality of antennas on a basis of a result of calculating cross-correlation between the one of the plurality of pieces of waveform data in which one of the plurality of Doppler variation compensation circuitries has compensated for the Doppler shift variation and each of known signals to which different types of frequency shifts are added, extracting a section of the detected signal frame from the one of the plurality of pieces of waveform data, and outputting the section to one of the filters, and
each of the plurality of processing circuitries performs processing of the plurality of filters and the plurality of reception beam controllers included in one of the plurality of processing circuitries in a case where one or more of correlation values obtained as a result of calculating cross-correlation in the plurality of frame detectors included in the one of the plurality of processing circuitries unit are equal to or greater than a threshold.

7. The signal processing apparatus according to claim 5, wherein
each of the plurality of processing circuitries performs processing of the plurality of reception beam controllers included in the one of the plurality of processing circuitries in a case where signal power of at least one of a plurality of the narrowband signals extracted by the plurality of filters included in the one of the plurality of processing circuitries is equal to or greater than a threshold.

8. A signal processing method comprising:
compensating for a Doppler shift variation that is a time variation of a Doppler shift with respect to each of a plurality of pieces of waveform data indicating a waveform of a wireless signal having been received by a communication apparatus using each of a plurality of antennas;
extracting each of a plurality of narrowband signals having a bandwidth equivalent to a bandwidth of a desired signal or a bandwidth obtained by adding a predetermined margin to the bandwidth of the desired signal from each of the plurality of pieces of waveform data in which the Doppler shift variation has been compensated; and
performing reception beam control by an adaptive array for the plurality of the narrowband signals having been extracted.
